(19) United States
(12) Patent Application Publication
(10) Pub. No.: US 2017/0022088 A1
(43) Pub. Date: Jan. 26, 2017

(54) FORMING MANDREL WITH DIFFUSION LAYER FOR GLASS FORMING

(71) Applicant: SCHOTT AG, Mainz (DE)

(72) Inventors: Joerg Witte, Pfungstadt (DE); Ammar Naji, Frankfurt am Main (DE); Mathias Galetz, Frankfurt am Main (DE)

(73) Assignee: SCHOTT AG, Mainz (DE)

(21) Appl. No.: 15/218,740

(22) Filed: Jul. 25, 2016

(30) Foreign Application Priority Data
Jul. 23, 2015 (DE) 102015111993.5

(51) Int. Cl. C03B 23/045; C03B 23/09

(52) U.S. Cl. CPC C03B 23/045; C03B 23/095

(57) ABSTRACT

A glass molding tool is provided that includes a forming mandrel, a method for forming glass, and to an apparatus for hot forming of glass. The glass products obtained in this way may be used as pharmaceutical packaging. The forming mandrel reshapes at least a portion of a heated region of a glass precursor. The mandrel includes a heat-resistant core material and a diffusion layer that is in contact with the glass precursor during reshaping.

### CROSS REFERENCE TO RELATED APPLICATIONS

This application claims benefit under 35 U.S.C. §119(a) of German Application No. 10 2015 111 993.5 filed Jul. 23, 2015, the entire contents of which are incorporated herein by reference.

### BACKGROUND

1. Field of the Invention

The invention generally relates to the manufacturing of glass products. More particularly the invention relates to a molding tool which comprises a forming mandrel, to a method and to an apparatus for hot forming of glass. The glass products obtained in this way can be used as a pharmaceutical packaging, for example.

2. Description of Related Art

In the manufacturing of hollow-body glass products, hot forming is an essential process step. The process flow in hot forming usually comprises a plurality of successive heating and molding processes performed to produce the desired final geometry starting from tubular glass bodies.

Hollow-body glass products that are to be used in the medical field are usually subject to very high requirements in terms of possible contamination resulting from the hot forming process. This implies stringent requirements on the molding tools used in hot forming. These stringent requirements in particular concern the materials used for the molding tools. For example, when making hollow-body glass products typically a cone is formed using a molding tool that comprises a forming mandrel. The material of the forming mandrel plays a crucial role in this case.

In the production of pharmaceutical packaging or in the hot forming of medical glass storage containers for drugs, such as ampoules, syringes, vials, cartridges, tungsten is used as a forming mandrel material, for example, besides other metallic forming materials made of steel.

Pure tungsten or tungsten alloys exhibit a high thermo-mechanical resistance which is highly beneficial in particular in the case of small material cross sections. This is the case, for example, with forming mandrels which have a diameter of less than 0.5 mm to about 1 mm. Therefore, mandrels which comprise tungsten or tungsten alloys in the contact area to the glass to be reshaped are advantageous.

When producing, for example, syringes from tubular glass bodies which is usually performed on indexed machines, e.g. rotary transfer machines, the forming mandrel is heated to temperatures of about 800° C. to 900° C. during hot forming. Because of the short cycle times, the material is subjected to frequent and rapid temperature changes. The influence of temperature, glass evaporation products, air, moisture, and the tribological load due to the doughy glass that is pressed against the mandrel during hot forming may therefore cause material erosion on the forming mandrel.

This material erosion on the forming mandrel, in particular in the contact area to the glass precursor to be reshaped, is generally undesirable and causes an alteration in the outer geometry of the forming mandrel or a reduction in diameter, and moreover this reduction in diameter is often not uniform in axial direction. This material erosion has several other negative effects.

Inter alia, as a result thereof, the predetermined nominal dimensions for shaping will be less and less respected over time, due to the altered outer geometry of the forming mandrel, and so the required channel dimensions can only be met for a limited time period. Thus, the service life of the forming mandrel is comparatively low and/or additional effort will be required for subsequent adjustments. Furthermore, the eroded material might get into the interior of the glass product just formed. During shaping of syringe cones, for example, eroded material might be introduced into the so-called cone channel.

Pharmacological active substances that are stored in the syringes, however, might interact with the tungsten-containing impurities in the interior of the glass product, so that the effectiveness thereof might be altered. Therefore, for special pharmaceutical active substances, glass vessels with a specific upper limit of the tungsten content are increasingly demanded.

For preventing tungsten-containing impurities, document EP 1 809 579 B1 therefore proposes to use a tungsten-free forming mandrel.

Furthermore, document WO 2012/039705 A2 proposes a forming mandrel which comprises a protective layer in the form of an overlay layer. The base material may contain tungsten in this case. For the layer material, a material contained in neutral glass is proposed, or a glass which constitutes a component of the glass to be reshaped, in order to prevent foreign contaminants in this way.

However, such a coating of the forming mandrel does not mean that the adverse effect of material erosion of the forming mandrel can be prevented. Therefore, the service life of such a forming mandrel is rather low.

Furthermore, cracking of layer material or chipping of layer components may occur due to the high mechanical stress, so that the service life of the forming mandrel is further reduced.

### SUMMARY

The object of the present invention resulting therefrom is to provide a material for a molding tool, in particular for a forming mandrel, as well as a method and an apparatus for forming hollow-body glass products.

The ingress of unwanted impurities, in particular tungsten, into the glass product to be reshaped by the molding tool, in particular by the forming mandrel, shall be reliably precluded. In particular the interior or the inner cone of the reshaped glass product shall remain free of contaminations from the molding tool, in particular the forming mandrel.

Furthermore, the molding tool, in particular the forming mandrel, shall have a long service life. Material erosion shall possibly be prevented, so that a particularly long service life can be achieved with consistent quality and without additional adjustment effort.

Moreover, spalling of outer components of the molding tool, in particular the forming mandrel, should be largely eliminated.

Finally, the risk of cracking in the surface of the forming mandrel should be avoided.

It would furthermore be desirable to be able to use the material tungsten at least as a base material, since it has very good thermal and chemical properties with respect to the hot forming of glass products.

This object is achieved in a surprisingly simple way by the subject matter of the present application.

Accordingly, the invention relates to a molding tool for reshaping hollow-body glass precursors, the molding tool comprising a forming mandrel for reshaping at least a portion of a heated region of the glass precursor, wherein the forming mandrel comprises at least one heat-resistant core material and a diffusion layer, and wherein the diffusion layer covers at least the surface area of the forming mandrel, which contacts the glass precursor during the forming process.

Furthermore, the invention provides an apparatus for reshaping hollow-body glass precursors, comprising: means for locally heating a region of a glass precursor to above its softening point; and at least one molding tool for reshaping at least a portion of the region of a glass precursor that is heated by the means for locally heating, wherein the molding tool comprises a forming mandrel according to the invention.

The apparatus may comprise a burner for local heating, and additionally rotation means are provided to rotate the forming tool and the glass precursor relative to each other.

The molding tool may furthermore comprise a pair of rollers arranged so that the rollers of the roller pair are rolling on the surface of a glass precursor that is rotated by the rotation means while the laser light is illuminating an area of the circumferential surface of the glass precursor lying between the rollers.

In a further embodiment, the apparatus may further comprise a laser for local heating. In this case, the molding tool is preferably designed so that a surface area of the portion to be reshaped of the glass precursor is not covered by the molding tool, and the laser or an optical system downstream of the laser is arranged so that during reshaping the laser light is irradiated onto the area not covered by the molding tool, and wherein a control device is provided which controls the laser so that the glass precursor is at least temporarily heated by the laser light during the reshaping process.

For heating the glass of a glass precursor to be reshaped in the apparatus, a laser is used which emits light of a wavelength to which the glass of the glass precursor is at the most partially transparent, so that the light is at least partially absorbed in the glass.

The method for reshaping glass products which can be performed with such an apparatus is accordingly based on the steps of locally heating a hollow-body glass precursor to above its softening point; and reshaping, with at least one molding tool, at least a portion of a region of the glass precursor that has been heated by means for locally heating; wherein the molding tool comprises a forming mandrel according to the invention as described above, and wherein the glass precursor and the molding tool are rotated relative to each other by rotation means.

The molding tool of the invention is particularly suitable for producing pharmaceutical glass packaging with low contamination.

Accordingly, the invention also relates to a glass syringe produced or producible by a method as described above, which has only very little or no contamination, in particular only very little or no tungsten contamination in particular in the interior thereof.

The inventors have found that a molding tool for reshaping hollow-body glass precursors which comprises a forming mandrel with a diffusion layer is particularly suitable for reshaping a portion of the glass precursor that is heated by means for locally heating.

As a base or core material of the forming mandrel, a material is preferred which exhibits high heat resistance and a high modulus of elasticity, so that it is appropriate for the mechanical loads even at temperatures in a range of 400° C. or more. Furthermore, it should be resistant to acids and glass evaporation products such as borates, and should exhibit oxidation resistance in air up to 400° C. to avoid material erosion during or caused by the hot forming processes.

Suitable base materials are the noble metals and their alloys, such as platinum. A particularly preferred base or core material for a forming mandrel according to the invention is tungsten or tungsten-containing alloys.

Wolfram is distinguished by a high resistance to acids such as HF and HCl and is only slightly attacked by sulfuric acid. Furthermore, it exhibits good oxidation resistance in air up to 400° C. In addition, high heat resistance and a high modulus of elasticity are favorable for being used as a core material for a forming mandrel. The term core material refers to a material of the forming mandrel which is essential for hot forming.

Surprisingly, material erosion of the core material of the forming mandrel, in particular of tungsten-containing core material, can be prevented or at least greatly reduced by providing a diffusion layer in the outer peripheral zone of the core material. The diffusion layer is characterized by comprising an additional material other than the core material.

Diffusion layers are further distinguished by the fact that the layer composition changes in the direction of the surface normal. They may be applied on the material by various methods. Diffusion layers may as well be produced by implantation techniques.

Usually, thermal diffusion of the deposited material into the base material is performed at temperatures between 500° C. and 1200° C., the exact temperatures depending on the relevant core material and the introduced material. Diffusion layers may, for example, be generated by high-temperature CVD processes, such as pack cementation. Such a method is described in document DE 691 10 286 T2, for example, and in document WO 2012/089200 A1.

Pack cementation exploits diffusion of a material or of a plurality of materials to form a surface coating. A substrate material is contacted with a material of a metal source in a manner so that a metal from the material of the metal source is able to diffuse into the substrate material.

In pack cementation, a substrate material is introduced into a powder mixture that contains both a metal intended to react with the substrate material and an inert material. Additionally, an activator from the group of halides may be used, which is present in the pack in form of a solid or liquid substance at room temperature, for example FeCl₃, AlCl₃, NH₄Cl, or which is supplied through the gas, for example as HCl or directly as SiCl₄ and causes the material of the metal source to get into a gaseous state.

The metal may as well be supplied in the gaseous state as a pure substance or as a compound. It is also possible that the metal melts in the process and reacts with the substrate in this state. The gaseous material of the metal source reaches the substrate material and is deposited on the surface thereof as a metal (decomposition reaction). Due to the high temperature, the deposited metal will diffuse into the substrate material to form a diffusion layer in a near-surface zone of the substrate material. Depending on the selected temperature, duration of the process, and type of metal, diffusion zones of different thicknesses may be formed in the substrate material. Also depending on the combination of materials and the process parameters, phase formation may take place within the diffusion zone. Additionally, depending on the material combination, a reducing gas atmosphere is generated during the coating process in which an appropriate gas mixture flows through the coating chamber. This process may as well be performed under negative pressure (vacuum).

The presence of other elements in the diffusion zone and/or a phase formation may result in an alteration of the properties in the peripheral zone, such as the corrosion behavior of the substrate material.

Here, tungsten or a tungsten-containing alloy may be used as the core material of the forming mandrel. The so produced diffusion layer has a high density and uniform thickness.

The forming mandrel with diffusion layer is further distinguished by the fact that impurities which are introduced during reshaping into the glass product to be reshaped by the molding tool can be reduced to a minimum. In particular an interior or an inner cone of the reshaped glass product remains free of impurities, especially tungsten impurities.

Therefore, the forming mandrel with diffusion layer according to the invention can be employed to produce syringes as a pharmaceutical packaging which exhibit very low contamination in particular in the cavity and/or in the inner cone portion of the syringe.

Contamination with the element tungsten may be in a range of less than 500 ng, preferably less than 300 ng, and most preferably less than 100 ng per syringe. In particular in the interior of the syringe, the contamination with tungsten can be very low, in particular with a content of tungsten in a range of more than 0.1 ng, more than 1 ng, more than 10 ng. Such an amount of tungsten is harmless in general.

The detection of tungsten contamination is accomplished using an aqueous extraction method in which the internal volume of the syringe is washed. This is done at elevated temperature (typically 50° C. up to 100° C. and more). Chemical detection of tungsten is made in the eluate, by inductively coupled plasma mass spectrometry (ICP-MS).

Another advantage of the invention is that depending on the concentration gradient a difference in the expansion behavior between the core material and the diffusion layer can be better compensated as compared to overlay layers which are often only slightly linked and bonded to the base material. In this way, the risk of chipping of outer parts of the forming mandrel is largely reduced. At the same time the risk of cracking is minimized.

According to its mode of action, the diffused material may act as a reservoir for the formation of an outer passivation layer when external damage arises. In this manner, a very long service life of the forming mandrel can be achieved. Moreover, it is possible in this way to achieve a particularly consistent high quality of the reshaped glass product without any need for frequent additional adjusting operations on the apparatus.

As stated above, intermetallic phases may be generated with the diffused material in a near-surface zone of the base material, i.e. in the core material of the forming mandrel. This defines the so-called diffusion zone. In the outermost zone, a stable oxide layer may be produced which constitutes a passivation layer and prevents oxidation of the underlying material. In this manner, oxidation protection layers can be produced, which generally form thermodynamically stable oxides, e.g. silicon oxide (SiO₂), aluminum oxide (Al₂O₃), titanium oxide (TiO₂), or chromium oxide (Cr₂O₃). This passivation layer prevents further oxidation.

These metals, for example aluminum, silicon, chromium, have a higher affinity to oxygen than tungsten and form thermodynamically very stable oxides.

A forming mandrel with diffusion layer according to the invention is characterized by a minimum content of the diffusion material of at least 40 atomic percent, measured at the surface of the forming mandrel. This applies, for example, to silicon as the diffusion material.

In a particularly preferred embodiment, tungsten is selected as a core material, and silicon as a diffusion material. By pack cementation, near-surface diffusion of elemental silicon into the outer peripheral zones of the forming mandrel can be achieved. This allows intermetallic compounds to be formed in a near-surface zone, for example tungsten silicides in the form of WSi₂.

The produced tungsten silicide is highly resistant to oxidation, similar to molybdenum silicide. At temperatures above 500° C. in an oxygen-containing atmosphere, this so-called silicidation of the tungsten or tungsten-containing surface of the forming mandrel causes, inter alia, the formation of a stable SiO₂ layer on the surface of the forming mandrel, so that the surrounding oxygen does not react with the tungsten but is bonded by the silicon as silicon oxide. Thus, the oxidation behavior is significantly improved, which has a very positive influence on the corrosion wear of the forming mandrel in use. A heat treatment prior to the use of a so-called siliconized forming mandrel under an oxygen-containing atmosphere results in the formation of a passivation layer. The heat treatment may be performed between 500° C. and 800° C. in air for a period of about 1 hour.

The layer thickness of the diffusion layer of the siliconized forming mandrel ranges from 1 to 200 μm, preferably from 1 to 100 μm, and more preferably from 1 to 20 μm.

In a further preferred embodiment, an aluminum-based diffusion layer may be generated in the forming mandrel. Here, again, the core material may comprise or contain tungsten. At high temperatures in air this diffusion layer also leads to a formation of a stable aluminum oxide layer which prevents further oxidation of the base material. Thereby, corrosion wear of the forming mandrel in the hot forming process with glass is significantly reduced.

A heat treatment prior to the use of this so-called aluminized forming mandrel under an oxygen-containing atmosphere leads to the formation of a passivation layer. The heat treatment may be performed between 500° C. and 800° C. in air for a period of about 1 hour. As a result of preliminary passivation, the release of tungsten compounds into the glass product during use is further reduced.

The thickness of the diffusion layer of the aluminized forming mandrel ranges from 1 to 300 μm, preferably from 5 to 90 μm.

A forming mandrel provided with a diffusion layer based on silicon or aluminum and with a core material comprising tungsten or tungsten-containing alloys offers many advantages.

These include a significantly increased service life, since the loss of mass attributable to material erosion or to a formation of volatile oxides is significantly reduced by the silicided or aluminized near-surface zone.

Another big advantage is that due to the lower corrosion wear significantly less particles are deposited in the contact area with the glass precursor to be reshaped, for example in the contact area with the cone channel of a syringe. At the same time, significantly less volatile tungsten components are introduced into the interior of the hollow-body glass product such as the interior of the syringe. Thus, the chemically analytically detectable tungsten content is considerably reduced. Therefore, the molding tool according to the invention, in particular the forming mandrel according to the invention is particularly suitable for use in hot forming of glass products which are employed as pharmaceutical packaging.

Additionally, a particularly high degree of dimensional accuracy is ensured, since material erosion on the forming mandrel is reduced. This permits to meet tight tolerances with respect to the geometry of the glass product.

The molding tool, in particular the forming mandrel, may comprise tungsten or tungsten alloys. In a particularly preferred embodiment, the molding tool therefore comprises a forming mandrel with a core material having a tungsten content of at least 70 wt %, preferably at least 90 wt %, more preferably at least 95 wt %, and most preferably at least 99.9 wt %.

The forming mandrel may as well comprise modified tungsten basis alloys as a core material. The following ODS tungsten basis alloys have been found particularly suitable: tungsten-zirconium oxide (W—ZrO₂), tungsten-cerium oxide (W—CeO₂), and tungsten-lanthanum oxide (W—La₂O₃). The acronym “ODS” and the term “ODS alloy” refers to “oxide dispersion strengthened” and “oxide dispersion strengthened alloy”, respectively.

In the case of tungsten-zirconium dioxide (W—ZrO₂), the proportion of added dispersed ZrO₂ is from 0.01 wt % to 2.5 wt %, preferably from 0.1 to 2.2 wt %, more preferably from 0.7 to 0.9 wt %.

In the case of tungsten-cerium oxide (W—CeO₂), the proportion of added dispersed CeO₂ is from 0.01 wt % to 2.5 wt %, preferably from 0.1 wt % to 2.5 wt %, and more preferably from 1.8 wt % to 2.2 wt %.

In the case of tungsten-lanthanum oxide (W—La₂O₃), the proportion of added dispersed La₂O₃ is from 0.01 wt % to 2.5 wt %, preferably from 0.1 wt % to 2.5 wt %, and more preferably from 1.8 wt % to 2.2 wt %.

In addition, potassium-doped alloys have been found particularly suitable. Potassium-doped tungsten alloys exhibit an increased recrystallization temperature and recovery temperature.

Particularly suitable are tungsten basis alloys with a potassium content between 5 and 100 ppm, preferably between 30 and 80 ppm, and more preferably between 50 and 70 ppm.

Besides heat-resistant pure tungsten or tungsten alloys, the core material of the forming mandrel may also comprise noble metals or alloys thereof. These include platinum and rhodium, and alloys thereof, for example.

The forming mandrel may comprise further materials. For example, the forming mandrel may comprise a ceramic base material, for reasons of stability, on which the core material of the forming mandrel is applied.

Preferably, the diffusion layer is provided in at least that region of the surface of the forming mandrel which will be in contact with the glass precursor during the reshaping process. This is usually at least the distal outer lateral surface towards the tip of the forming mandrel.

### BRIEF DESCRIPTION OF THE DRAWINGS

The invention will now be described in more detail by way of preferred embodiments and with reference to the accompanying figures. Further details of the invention will be apparent from the description of the illustrated exemplary embodiments and the appended claims. In the drawings:

FIG. 1 illustrates components of an apparatus for reshaping tubular glass;

FIG. 2 shows a transmission spectrum of a glass of a glass precursor;

FIGS. 3A-3F are sectional views through a tubular glass during the reshaping process;

FIG. 4 is a plan view of a portion of a forming mandrel with a diffusion layer;

FIG. 5 is an overview of material properties of tungsten;

FIG. 6 shows a transverse microsection through a silicided forming mandrel in a detail enlargement;

FIG. 7 shows a transverse microsection through an aluminized forming mandrel in a detail enlargement;

FIG. 8 shows a longitudinal microsection through a silicided forming mandrel in a detail enlargement after use;

FIG. 9 shows a further longitudinal microsection through a silicided forming mandrel in a detail enlargement after use;

FIG. 10 shows a non-treated tungsten mandrel after use; and

FIG. 11 shows a metallographic longitudinal microsection through a non-treated tungsten mandrel after use.

### DETAILED DESCRIPTION

In the following detailed description of preferred embodiments, similar components in or on these embodiments are designated by the same reference numerals, for the sake of clarity. However, in order to better illustrate the invention, the preferred embodiments shown in the figures are not always drawn to scale.

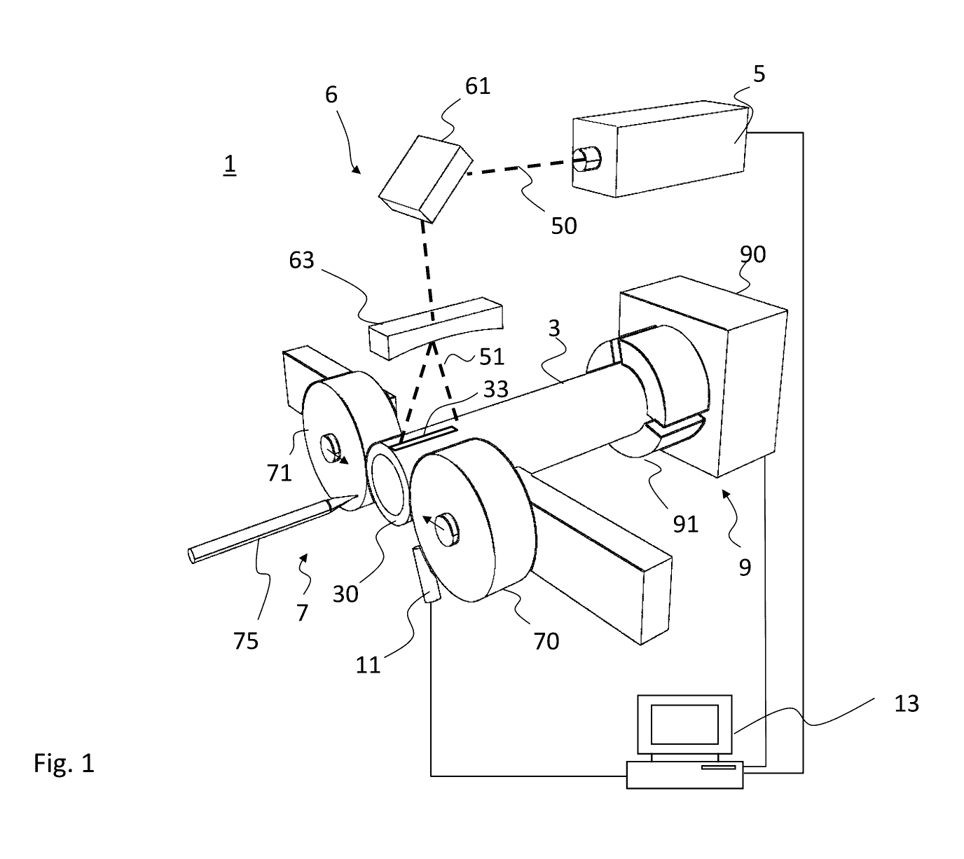

FIG. 1 illustrates an exemplary embodiment of an apparatus 1 for performing the method of the invention.

The apparatus designated by reference numeral 1 as a whole of the exemplary embodiment shown in FIG. 1 is configured for reshaping glass precursors in the form of tubular glass 3. Specifically, the apparatus is used for producing glass syringe bodies, and the elements of apparatus 1 shown in FIG. 1 serve to form the cone of the syringe body from the tubular glass.

The generation of the cone from the tubular glass by means of apparatus 1 basically comprises local heating of a region of a tubular glass 3 to above the softening point thereof, here the end 30 thereof, and reshaping of at least a portion of the heated end using at least one molding tool. In the illustrated example, the means for locally heating comprise a laser 5 which emits light of a wavelength to which the glass material of glass tube 3 is at most partially, i.e. not fully transparent, so that the light is at least partially absorbed in the glass.

Instead of the laser 5 for locally heating a hollow-body glass precursor as illustrated in FIG. 1, it is of course also possible to use other means for local heating, which are typically employed for glass hot forming processes. This may be a burner, for example, such as a gas burner. Since the use of such devices is well known, a detailed description thereof is omitted here.

The laser beam 50 of FIG. 1 is directed onto the tubular glass 3 by means of an optical system 6. During the reshaping process, the molding tool 7 and the glass precursor 3 are rotated relative to each other, by rotation means 9. As in the illustrated example, it will usually be favorable to rotate the tubular glass 3 with the axis of rotation along the axial extension of the tubular glass 3. For this purpose, rotation means 9 comprise a drive 90 with chuck 91 which holds the tube glass 3. Another possibility would be an inverted configuration in which the tube glass is fixed and the molding tool 7 rotates around the tubular glass.

In the exemplary embodiment shown in FIG. 1, molding tool 7 comprises two rollers 70, 71 which roll on the surface of the tubular glass 3 while the latter is rotated. The end 30 of tubular glass 30 is compressed by driving the rollers to approach each other in the radial direction of tubular glass 3. The radial movement is illustrated in FIG. 1 by arrows on the axes of rotation of rollers 70, 71. Furthermore, a forming mandrel 75 is provided as a component of molding tool 7. This forming mandrel 75 is introduced into the opening of tubular glass 3 at the end 30 to be deformed. By means of forming mandrel 75, the cone channel of the syringe body is formed. Forming mandrel 75 may be rotatably mounted so as to rotate together with tubular glass 3. It is also possible to have the rotating glass sliding on and around the stationary forming mandrel.

To avoid adhesion, a releasing agent or lubricant which reduces friction in the sliding movement can be used for this purpose, as is usual with molding tools sliding over a glass surface. Furthermore, it is possible to use a lubricant which evaporates at the temperatures employed during reshaping. If such a lubricant is used, lubricant or releasing agent residues on the finished glass product can advantageously be avoided.

Between rollers 70, 71 the laser beam 50 can be directed onto the tubular glass without having the laser beam 50 interrupted by the molding tool. Accordingly, the molding tool is configured so that a surface region of the portion to be reshaped of the tubular glass is not covered by the molding tool, so that by means of optical system 6 arranged downstream of the laser the laser light is irradiated onto the region not covered by the molding tool during the reshaping process. Specifically, an area 33 between rollers 70, 71 on the circumferential surface of the tubular glass 3 is illuminated by the laser light.

The reshaping process is controlled by a control device 13. In particular, control device 13 drives the laser 5 so that during the reshaping process the tubular glass 3 is at least temporarily heated by the laser light.

Optical system 6 of the apparatus shown in FIG. 1 comprises a deflection mirror 61 and a cylindrical lens 63.

Cylindrical lens 63 is provided for expanding the laser beam 50 into a fan beam 51 along the axial direction of the tubular glass 3 so that the area 33 illuminated by the laser light is expanded accordingly in the axial direction of tubular glass 3. Since tubular glass 3 is rotated while the laser light is irradiated, the irradiated power is distributed circumferentially on the tubular glass, so that a cylindrical portion is heated, or more generally, regardless of the shape of the glass precursor, a region in the axial direction along the rotation axis. This region has a length which is preferably at least as long as the portion to be reshaped. The latter has a length which is substantially determined by the width of the rollers. To achieve special laser power distributions in the axial direction of the tubular glass, it is also possible, alternatively or additionally to the cylindrical lens 63, to advantageously use a diffractive optical element.

The forming process is controlled by control device 13. Among other things, control device 13 controls the laser power. Furthermore, the movement of molding tools 70, 71, 75 is controlled. Also, rotation means 9 can be controlled, in particular the rotational speed of drive 90, optionally also the opening and closing of chuck 91.

When forming glass syringe bodies, a radiation power of less than 1 kilowatt will generally be sufficient for the laser 5 to ensure rapid heating to the softening temperature. Once the intended temperature for hot forming has been reached, the laser power may then be reduced by control device 13 so that the incident laser power only compensates for cooling. When producing syringe bodies, between 30 and 100 watts will generally be sufficient for this purpose.

Controlling of the laser power may in particular be accomplished based on the temperature of the tubular glass 3. For this purpose, a control process may be implemented in control device 13, which controls the laser power based on the temperature as measured by a temperature measuring device so as to adjust a predetermined temperature or a predetermined temperature/time profile in the glass precursor. In the example shown in FIG. 1, a pyrometer 11 is provided as the temperature measuring device, which measures the thermal radiation of the tubular glass at the end 30 heated by laser 5. The measured values are supplied to control device 13 and used in the control process for adjusting the desired temperature.

A particular advantage of the setup as exemplified in FIG. 1 is that the laser light is not directly heating the molding tools. As a result thereof, although the glass precursor is heated during the reshaping process, the molding tools will usually not be heated more than in a process with preceding heating by a burner. Overall, less thermal energy is produced in this way, and moreover this thermal energy is introduced into the glass precursor more selectively.

Thus, heating of the entire apparatus is reduced, and therefore also running-up phenomena caused by thermal expansions, inter alia.

A preferred glass for the production of syringe bodies is borosilicate glass.

Particularly preferred is low-alkali borosilicate glass, in particular with an alkali content of less than 10 percent by weight. Borosilicate glass is generally well suited due to its typically high thermal shock resistance which is favorable to realize rapid heating ramps at the fast processing times that can be achieved with the invention.

A suitable low-alkali borosilicate glass comprises the following constituents, in percent by weight:

| | | |
|---|---|---|
| SiO₂ | 75 | wt %, |
| B₂O₃ | 10.5 | wt %, |
| Al₂O₃ | 5 | wt %, |
| Na₂O | 7 | wt %, and |
| CaO | 1.5 | wt %. |

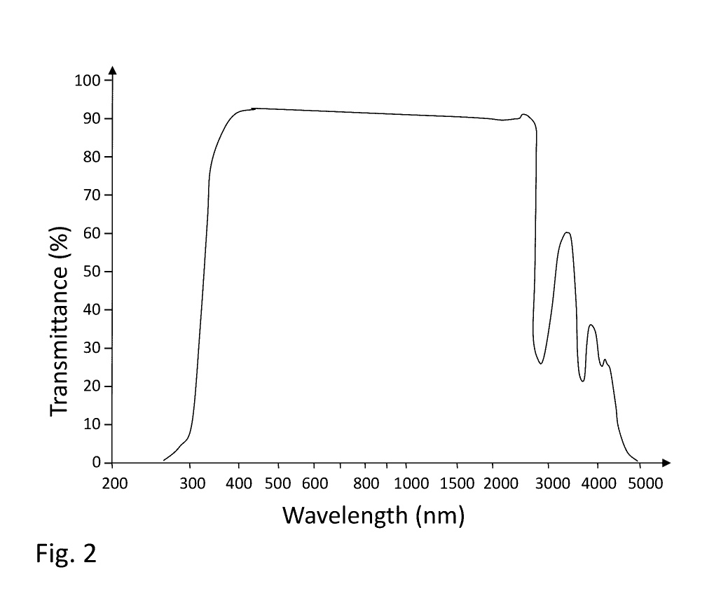

FIG. 2 shows a transmission spectrum of the glass. The transmittance values given refer to a glass thickness of one millimeter. As can be seen from FIG. 2, transmittance of the glass decreases at wavelengths above 2.5 micrometers. Above 5 micrometers the glass is substantially opaque, even in case of very thin glass thicknesses.

The decrease in transmittance in the wavelength range above 2.5 micrometers as shown in FIG. 2 is not significantly dependent on the exact composition of the glass. Thus, in preferred borosilicate glasses the contents of the constituents given above may even deviate by 25% from the respective given value, with similar transmission properties. Furthermore, glasses other than borosilicate glass may of course be used as well. As long as these glasses are at most partially transparent, i.e. not fully transparent at the wavelength of the laser, a laser source can be used for heating.

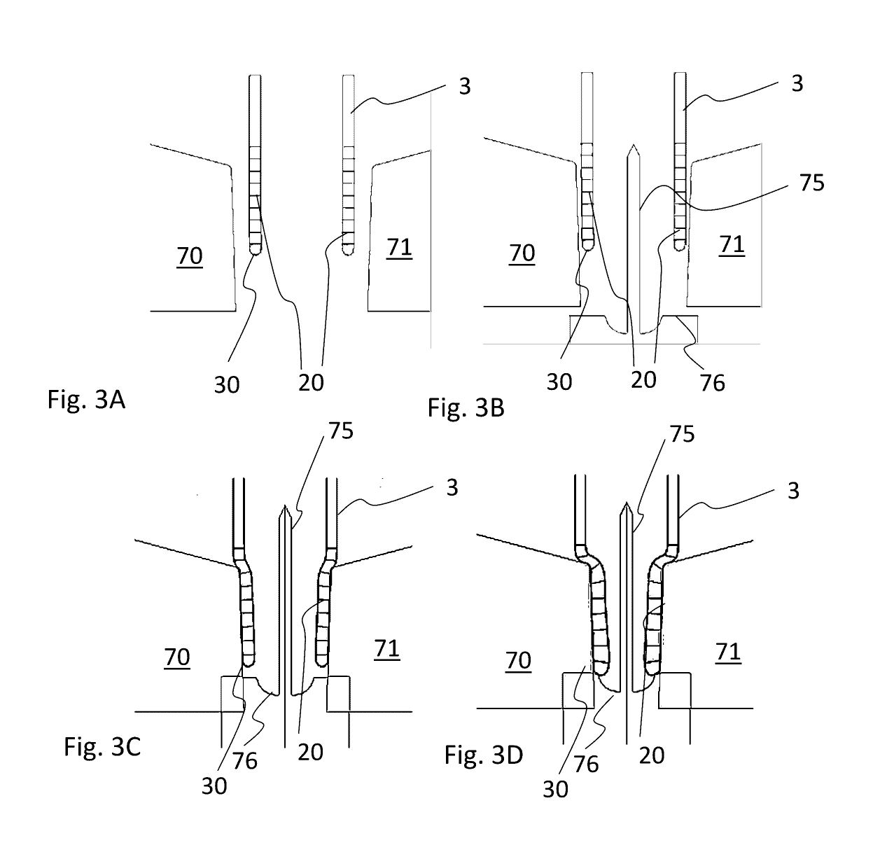

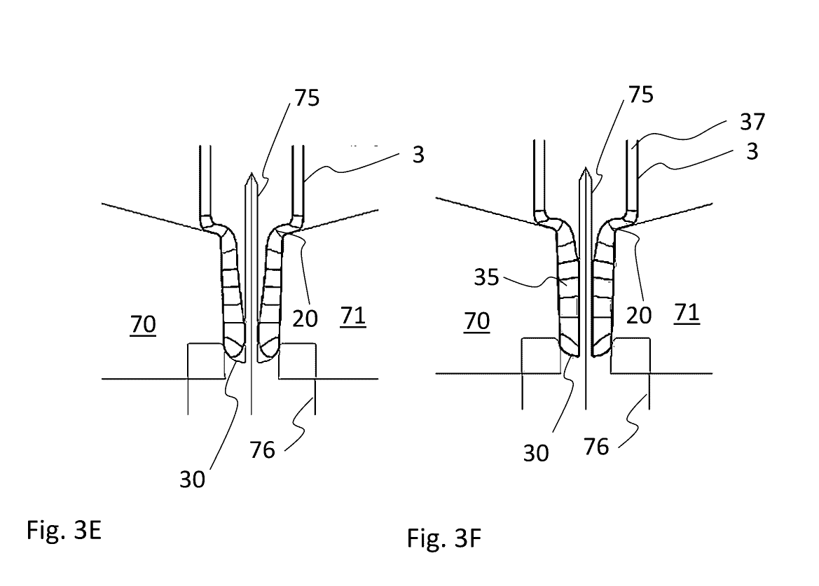

FIGS. 3A to 3F are sectional views illustrating a simulation of a reshaping process according to the invention for forming a syringe cone from a tubular glass 3 in order to produce a syringe body. The sections of the drawings are taken along the center axis of the tubular glass 3 around which the tubular glass is rotated. Rollers 70, 71 and mandrel 75 can also be seen.

Lines 20 as indicated in the sectional views of the tubular glass and initially extending perpendicularly to the center axis of the tubular glass are imaginary boundary lines of axial sections of the tubular glass 3. By way of these lines the material flow during reshaping is illustrated.

Forming mandrel 75 protrudes from a foot 76 which serves to shape the distal cone surface of the syringe. Foot 76 is a flat component perpendicular to the viewing direction of FIGS. 3A to 3F. Other than illustrated, the foot is rotated by 90° about the longitudinal axis of forming mandrel 75 in the actual apparatus, so that foot 76 fits between rollers 70, 71. That is to say, the overlapping of rollers 70, 71 and foot 76 as seen in FIG. 3C et seq. actually does not occur.

Engagement by rollers 70, 71 and initial deformation takes place starting with the position shown in FIG. 3C. Then, the tube glass 3 is compressed by rollers 70, 71 which are moved radially inwards toward the center axis of the tubular glass. In the stage shown in FIG. 3E, forming mandrel 75 contacts the inner surface of the tubular glass and forms the channel of the syringe cone. In the stage shown in FIG. 3F, finally, the shaping of the syringe cone has already been completed. Subsequently, the molding tools are retracted from the molded syringe cone 35. Thus, all forming steps for forming the syringe cone 35 were performed with the same molding tools 70, 71, 75 and foot 76. Such a forming station therefore performs all hot forming steps on a portion of the glass precursor. Subsequently, the syringe flange or finger rest on the other end of the tubular glass can be formed.

Starting from the shaping stage as illustrated in FIG. 3E it can clearly be seen that radial compression on the syringe cone 35 results in a thickening of the wall thickness. Now, there is an option to cause some material flow away from end 30 by setting an appropriate temperature distribution as described above. Also, a reduced wall thickness may be caused at the peripheral edges of the reshaped tubular glass in the transition area between syringe barrel 37 and syringe cone 35. This effect may be counteracted as well, by adjusting an axially inhomogeneous power input by controlling axial distribution of the laser power.

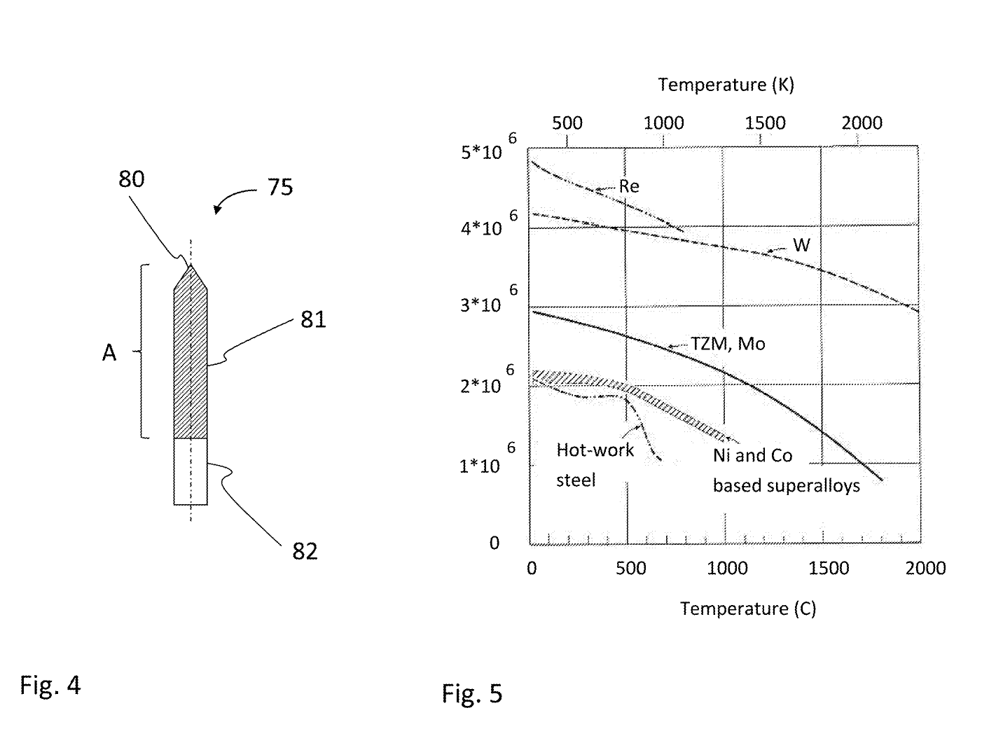

FIG. 4 is a plan view illustrating a portion of a forming mandrel 75. Starting from the top 80 of forming mandrel 75 a region adjacent to the tip of the forming mandrel 75 is marked by “A”, in which the lateral surface 81 of forming mandrel 75 will or may contact the glass precursor during reshaping. Therefore, it is at least this area which is or will be provided with the diffusion layer 81 of the invention. The lateral surface of forming mandrel 75 may further comprise an area 82 without diffusion layer. This portion may be used for mounting the forming mandrel, for example.

FIG. 5 is an overview (Source: Wolfram-Werkstoffeigenschaften and Anwendungen (Tungsten material properties and applications), Plansee AG, Reutte, 2000) representing the modulus of elasticity of tungsten compared to that of other alloys. Clearly visible is the comparatively high modulus of elasticity of tungsten and the high heat resistance thereof.

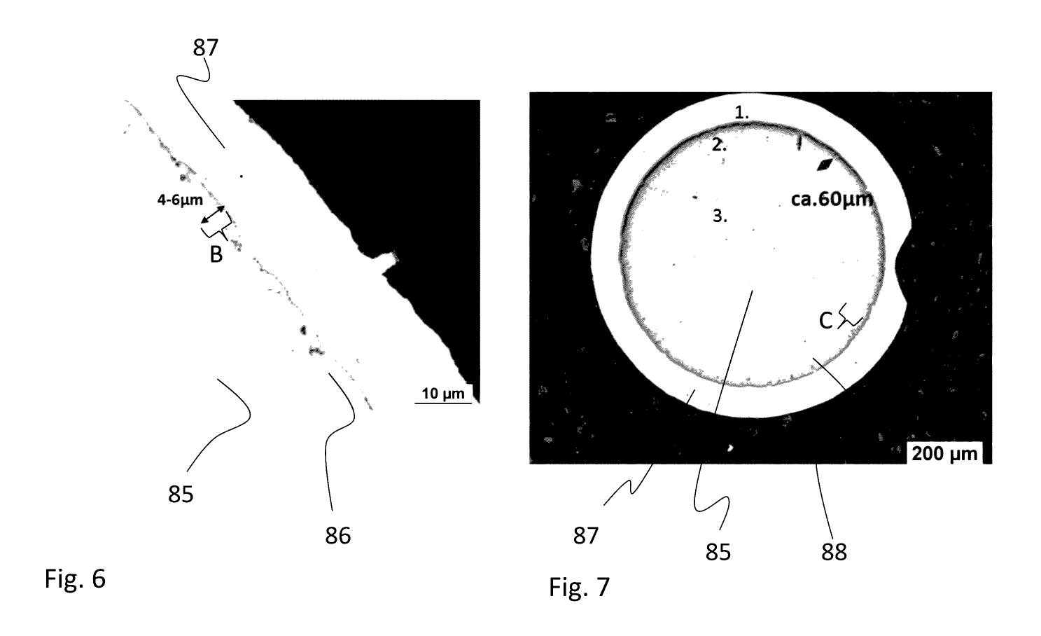

FIG. 6 shows a transverse microsection through a silicided forming mandrel in a detail enlargement. The forming mandrel comprises tungsten as a core material. The diffusion of silicon into the mandrel was performed at a temperature above 650° C. over a period of more than 8 hours by pack cementation.

The core material 85 of the forming mandrel can be seen in the transverse section. Also, a diffusion zone 86 can be seen, which is located at the surface of the forming mandrel and protrudes into the interior of the forming mandrel. The thickness of silicided diffusion zone 86 indicated by B is about 4 to 6 μm, preferably about 5 μm. Thus, the silicided diffusion zone 86 extends into the core material by about 5 μm as measured from the surface of the forming mandrel.

In order to protect the near-surface region during metallographic preparation, in particular during grinding and polishing of the mandrels, the mandrels are surrounded by a nickel coating. This layer 87 can be seen on forming mandrel 75. This layer 87 is not employed during the use of the mandrels in the hot forming of pharmaceutical packaging.

FIG. 7 shows a transverse microsection through an aluminized, or alitized, forming mandrel in a detail enlargement. The core material 85 of the illustrated forming mandrel 75 is made of tungsten. Furthermore, a diffusion zone 88 can be seen, which is marked by “C”. The alitized diffusion zone extends into the core material by about 50 to 70 μm, preferably by about 300 μm, as measured from the surface of the forming mandrel.

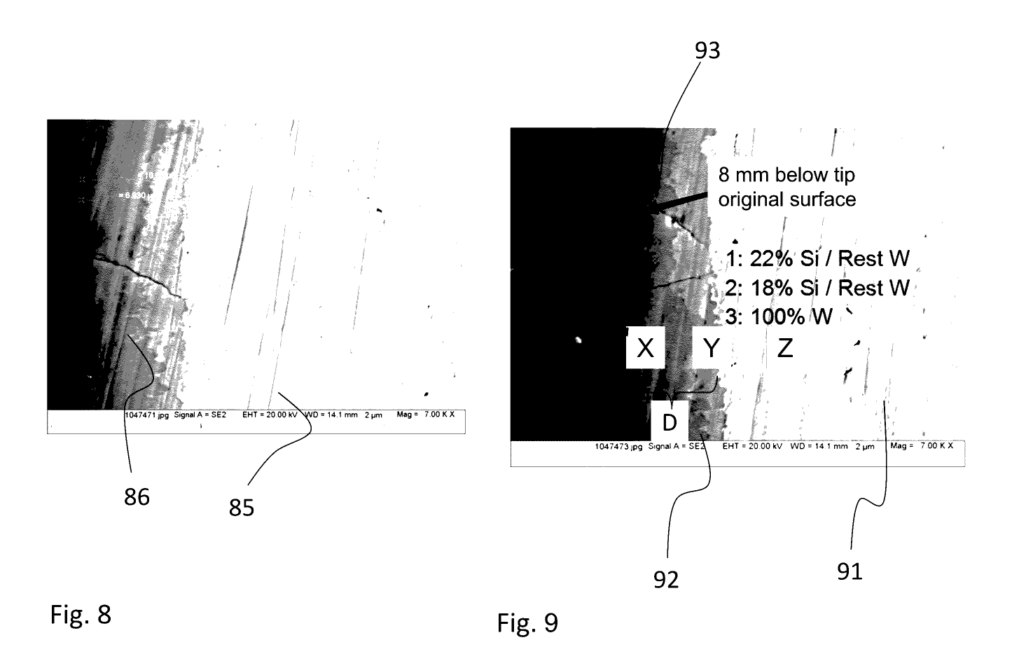

FIG. 8 shows a longitudinal microsection through a silicided forming mandrel in a detail enlargement after use. The presence of a diffusion layer 86 is clearly visible. In this example, a silicon diffusion layer was generated on the forming mandrel 75, and the forming mandrel was in use over an extended period of time. It has run through a number of about 10,000 cycles, i.e. reshaping processes, for hot forming syringes.

FIG. 9 shows a further longitudinal microsection through a silicided forming mandrel 91 in a detail enlargement after use. The presence of a diffusion layer 92 is clearly visible. The diffusion layer was generated on the basis of silicon and comprises a diffusion zone D with a thickness of about 10 μm. In this example, the forming mandrel 91 was in use over an extended period of time. It has run through a number of about 10,000 cycles, i.e. reshaping processes, for hot forming syringes.

The original outer edge of forming mandrel 91 is indicated by dashed line 93. It can be seen that the outer edge is still in very good condition. Moreover, the outer dimension is hardly changed after use. In particular, the outer edge still exhibits high straightness. Thus, the forming mandrel 91 having the surface provided with the silicided diffusion layer can therefore be regarded as exhibiting very low wear.

At the positions marked by X, Y, and Z, the silicon and tungsten contents were determined. In the region marked by Z, which defines a position in the core material of the forming mandrel, the tungsten content is 100 wt %. In the region marked by X, which is in the region of the diffusion zone D, a silicon content of about 22 wt % and a tungsten content of about 78 wt % were determined. In the region marked by Y, which is in a transition region in which the content of the diffused material decreases significantly, a silicon content of about 18 wt % and a tungsten content of about 82 wt % were found.

Starting from a relatively high value in the outer region of the diffusion zone near the surface of forming mandrel 91, which may be about 22 wt % or even higher in the example, the silicon content in the diffusion zone decreases inwardly.

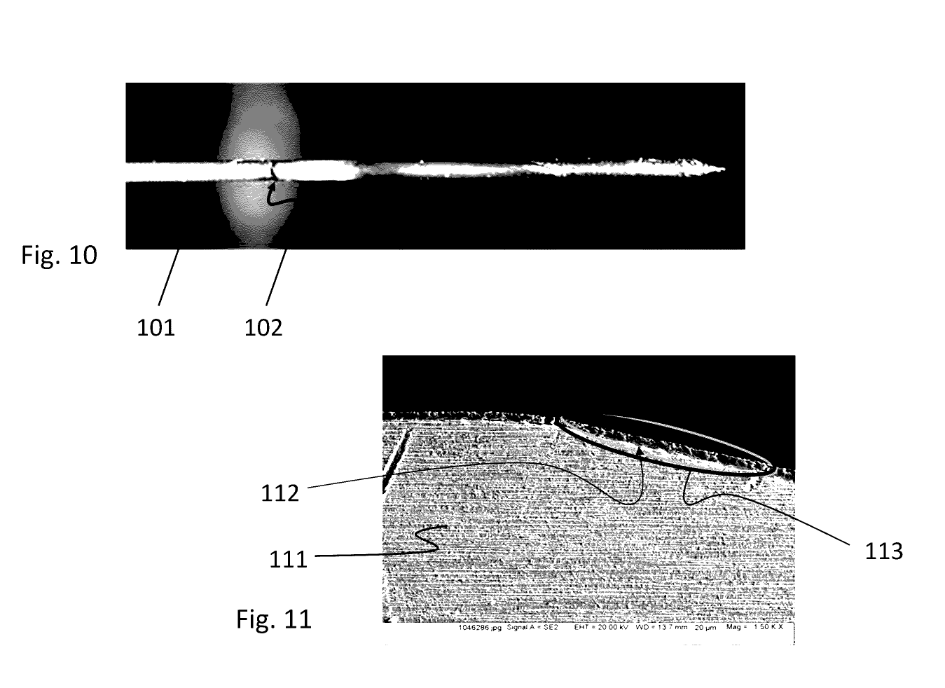

As a comparative example, FIG. 10 shows a non-treated tungsten mandrel 101 after use. The illustrated forming mandrel without the inventive diffusion layer has run through about 3,000 shaping steps. The coloring indicates a formation of surface oxides on the mandrel, clearly recognizable is a waisting 102 on the left side of the illustrated forming mandrel 101.

Finally, as a further comparative example, FIG. 11 shows a metallographic longitudinal microsection through a non-treated tungsten mandrel 111 after use. The illustrated forming mandrel without the inventive diffusion layer has run through about 3,000 shaping steps. In the marked oval 113, formation of an oxide layer is observable, which layer has a thickness of about 3 to 5 μm and which can be removed and reproduces itself.

A molding tool according to the invention, in particular a forming mandrel, has a number of advantages. It is possible in this way to continue to use the material tungsten which is very well suited for the hot forming of hollow-body glass precursors without however thereby causing any undesirable contamination, especially in the interior of the reshaped glass product.

This brings many advantages, in particular with regard to the manufacturing of pharmaceutical packaging, such as syringes, cartridges, ampoules, or vials. The invention is therefore particularly suitable for tungsten-free or low-tungsten pharmaceutical packaging, such as especially syringes.

What is claimed is:

1. A molding tool for reshaping a hollow-body glass precursor, comprising a forming mandrel for reshaping at least a portion of a heated region of the glass precursor, the forming mandrel having a heat-resistant core material and a diffusion layer, wherein the diffusion layer is provided at least at a surface of the forming mandrel that is in contact with the glass precursor during reshaping.

2. The molding tool as claimed in claim 1, wherein the core material comprises a noble metal and/or a transition element.

3. The molding tool as claimed in claim 1, wherein the core material comprises tungsten or a tungsten-containing alloy.

4. The molding tool as claimed in claim 3, wherein the core material has a tungsten content of at least 90 wt %.

5. The molding tool as claimed in claim 1, wherein the core material comprises tungsten-zirconium dioxide (W—ZrO₂) with a proportion of added ZrO₂ from 0.01 wt % to 2.5 wt %.

6. The molding tool as claimed in claim 5, wherein the proportion of added ZrO₂ is from 0.7 wt % to 0.9 wt %.

7. The molding tool as claimed in claim 1, wherein the core material comprises tungsten-cerium oxide (W—CeO₂) with a proportion of added CeO₂ from 0.01 wt % to 2.5 wt %.

8. The molding tool as claimed in claim 7, wherein the proportion of added CeO₂ is from 1.8 wt % to 2.2 wt %.

9. The molding tool as claimed in claim 1, wherein the core material comprises tungsten-lanthanum oxide (W—La₂O₃) with a proportion of added La₂O₃ from 0.01 wt % to 2.5 wt %.

10. The molding tool as claimed in claim 9, wherein the proportion of added La₂O₃ is from 1.8 wt % to 2.2 wt %.

11. The molding tool as claimed in claim 1, wherein the core material comprises a proportion of potassium between 5 and 100 ppm.

12. The molding tool as claimed in claim 11, wherein the proportion of potassium is between 50 and 70 ppm.

13. The molding tool as claimed in claim 1, wherein the diffusion layer comprises silicon (Si) and/or aluminum (Al).

14. The molding tool as claimed in claim 13, wherein the diffusion layer has a minimum content as measured at the surface of the forming mandrel that is at least 30 atomic percent.

15. The molding tool as claimed in claim 1, wherein the diffusion layer comprises silicon having a thickness from 1 to 200 μm.

16. The molding tool as claimed in claim 15, wherein the thickness is from 1 to 20 μm.

17. The molding tool as claimed in claim 1, wherein the diffusion layer comprises aluminum having a thickness 1 to 300 μm.

18. An apparatus for reshaping a hollow-body glass precursor, comprising:
a heating device configured to locally heat a region of the glass precursor to above a softening point; and
a molding tool for reshaping the region of the glass precursor heated by the heating device, wherein the molding tool comprises a forming mandrel having a heat-resistant core material and a diffusion layer, wherein the diffusion layer is provided at least at a surface of the forming mandrel that is in contact with the glass precursor during reshaping.

19. A method for producing a pharmaceutical packaging made of glass, comprising the steps of:
locally heating a region of a hollow-body glass precursor to above a softening point; and
contacting the region of the glass precursor with a surface of a forming mandrel to reshape the region, the surface being defined by a diffusion layer on a heat-resistant core.

20. The method as claimed in claim 19, wherein the region is an inner cone of a glass syringe, the inner cone having a content of tungsten of more than 0.1 ng and at most 500 ng.
